(19) United States
(12) Patent Application Publication
(10) Pub. No.: US 2015/0280367 A1
(43) Pub. Date: Oct. 1, 2015

(54) INSULATING BODY OF A PLUG-IN CONNECTOR

(71) Applicant: Harting KGaA, Espelkamp (DE)

(72) Inventors: York Dobrick, Osnabrueck (DE); Michael Schulte, Koeln (DE); Lutz Troeger, Osnabrueck (DE)

(21) Appl. No.: 14/360,761

(22) PCT Filed: Nov. 15, 2012
(86) PCT No.: PCT/DE2012/100348

§ 371 Date: May 27, 2014

(30) Foreign Application Priority Data
Nov. 28, 2011 (DE) 102011055750.4

(51) Int. Cl. H01R 13/6463; H01R 13/6592; H01R 24/64; H01R 13/46

(52) U.S. Cl. CPC H01R 13/6463; H01R 13/46; H01R 13/6592; H01R 24/64; H01R 2107/00

(57) ABSTRACT

The invention relates to an insulating body of a plug-in connector, wherein the insulating body is at least partially made from a metallisable plastic, and wherein the insulating body comprises at least one duct that is adapted for receiving a conductor. The crosstalk behaviour of the plug-in connector is improved by providing at least one duct in the insulating body with a conductive coating.

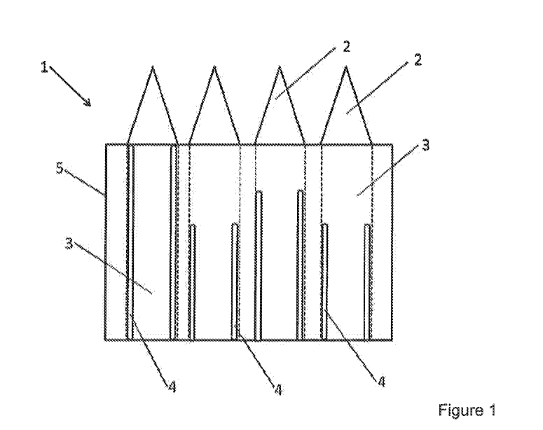

The invention relates to an insulating body of a plug-in connector according to the preamble of claim 1.

Insulating bodies are inserted into chambers of a plug-in connector housing provided for this purpose or are surrounded by a matching plug-in connector housing. As a rule, the insulating bodies also comprise contact members to which the individual conductors of a cable that are to be connected to the plug-in connector are connected.

Within the insulating body, the individual conductors of the connected cable are often run through cable ducts. Such insulating bodies are necessary in order to provide multi-pole plug-in connectors for analog or digital data transmission.

In conventional plug-in connectors, in particular in the case of RJ45 plug-in connectors, the individual conductors of the cable to be connected are for space reasons often run next to each other in very close proximity, which leads to so-called crosstalk of the data signals transported via the conductors, and thus altogether to a low data transmission quality.

There is a trend for data transfer with increasingly higher transmission frequencies on the market, and conventional plug-in connectors have an insufficient quality aspect.

The present invention provides an insulating body for a plug-in connector which, despite its small dimensions, has improved data transmission or signal quality.

The object is achieved by means of the characterising features of claim 1.

Advantageous embodiments of the invention are indicated in the dependent claims.

The insulating body according to the invention is made, at least partially, from a metallisable plastic. At least one duct is introduced into the insulating body, which duct is provided for receiving a conductor of a cable to be connected. As a rule, two or more such ducts will be provided in the insulating body, which are each suitable for receiving a conductor of a multi-core cable.

The internal wall of such a conductor duct is provided with a conductive coating. In this case, the conductive coating is in contact with the insulation of the individual conductor. However, it is also conceivable to provide the outer wall of such a conductor duct with the conductive coating. Up to now, for example metal sleeves pushed into the conductor duct have been used for this purpose.

Tests have shown that a complete metallisation of all conductor ducts of an insulating body of a plug-in connector has surprisingly not brought about any substantial improvements to the crosstalk behaviour of the plug-in connector. Depending on the plug-in connector type (RJ45, circular plug-in connector, with eight poles or with twelve poles, etc.) it may be advantageous to provide some individual ducts completely and others only partially with the conductive coating.

Advantageously, the conductive coating of the at least one duct is realised using MID technology.

MID (Moulded Interconnection Devices) technology is mainly used for generating complex 3-dimensional conductive path structures on components which provide printed circuit board functionality.

Various methods are known in MID technology. The LDS method is described in Patent Application No. DE 101 32 092 A1. For example, liquid crystal polymers, so-called LCP (Liquid Crystal Polymer), are used, which are moulded into components in an injection moulding process. By radiating with a laser, the areas on which conductive path structures are to be generated are activated in a targeted manner. By way of radiation using the laser, metal (e.g. palladium) that is chemically bound in the polymer is activated, as a result of which metal seeds are formed on the surface. Subsequently, a conductive metal layer is formed in a chemical bath by way of electroless chemical separation on the metal seeds formed. The first copper layer is substantially used for providing conductivity. In order to achieve even better electric conductivity, further metal layers may be separated. These further layers are moreover used for providing mechanical stability and for corrosion protection.

Alternatively, the metallisable plastic may be made in a two-component injection moulding process.

In two-component MID technology, a metallisable thermoplastic material, for example a plastic doped with palladium, is injected into a mould, where the surface to be provided with a conductive coating is imaged. In a second method step, the areas between and around this/these surface(s) are overmoulded with a non-metallisable thermoplastic material, as a result of which the workpiece—here the insulating body—receives its final shape. Subsequently, the selective metallisation of the surfaces to be provided with a conductive coating is carried out in a chemical bath. In this process a metal substance, preferably copper or a copper alloy, adheres to the doping substance. In further process steps, for example in galvanic baths, further metal compounds may be applied onto the copper surface.

Advantageously, the insulating body according to the invention is inserted into an RJ-45 plug-in connector. Multicore cables are connected to RJ-45 connectors, the individual conductors of which are surrounded by a shielding film and are twisted together. As a result, signal coupling (crosstalk) is avoided.

In order to guide the individual conductors of the cable to be connected to the contacts of the insulating body, the shielding of the individual conductors has to be removed and the twisting has to be divided. The missing insulation of some conductors within an insulating body without conductor ducts with a conductive coating leads to losses of quality during signal transmission, in particular in the case of high transmission frequencies.

The conductor ducts provided with a conductive coating according to the invention shield the individual conductors of the connected cable from each other, so that the signal quality rises significantly.

In an advantageous embodiment of the invention, the ducts are only partially provided with a conductive coating. In this case “partially” means that the ducts are not provided with a conductive coating over their entire axial length. Tests have shown that the crosstalk behaviour of RJ45 plus-in connectors is significantly improved if a conductive coating is provided only over 75% of the axial length of the ducts. It may also be advantageous if a conductive coating is provided only over 50% of the axial length of the ducts.

In a further advantageous embodiment, only one side of the duct is provided with a conductive coating. The lateral separation of the ducts is carried out along the axial axis thereof. Here, too, the duct (or ducts) is only partially provided with a conductive coating. This embodiment is achieved for example by implementing the insulating body in two parts and by the fact that only one half is made from a metallisable material.

It may also be advantageous if some ducts in the insulating body are provided with a conductive coating over their entire axial length and other ducts in turn only partially (75%, 50%). Depending on how the conductors are arranged relative to each other in the insulating body of the plug-in connector, the ducts may be differently provided with a conductive coating over their axial length. As a result, a plug-in connector may be realised with low crosstalk.

In a further advantageous embodiment, the conductive coatings of the individual conductor ducts are connected to a metallic housing of a plug-in connector via a conductive path. The conductive path is advantageously also made using the above-illustrated MID technology and is therefore also introduced into the insulating body.

As has already been mentioned above, a plurality of ducts in the insulating body would be provided with a conductive coating. Advantageously, at least two ducts provided with the conductive coating are electrically contacted with each other and in addition with the plug-in housing via a conductive connection.

An embodiment example will be illustrated below by means of a schematic drawing. However, the invention is not limited to such an embodiment example.

What is shown is a schematic cross section of an insulating body 5 of a plug-in connector (not shown). The insulating body 5 comprises contact members 2. The individual conductors of a cable to be connected to the plug-in connector are inserted into ducts 3 of the insulating body 5.

By means of an MID method, the individual ducts 3 are provided with a conductive coating 4. In an axial orientation of the insulating body 5, the conductive coating 4 is formed with different lengths. The length of the conductive coating in the ducts may be selected as a function of the crosstalk behaviour of the individual plug-in connector. In the case of an RJ45 plug-in connector, for example only from 50% to 75% of the lengths of the central ducts are provided with a conductive coating.

Moreover, the insulating body comprises a conductive connection (not shown) which connects the individual ducts 3 provided with a conductive coating 4 with each other in a conductive manner. Moreover, the conductive path is in conductive contact with a metallic plug-in connector housing and/or with the neutral conductor of the cable to be connected.

Provided the cable to be connected has a shielding, then this shielding may also be connected to the conductive path of the insulating body.

In a further advantageous embodiment of the invention, the entire surface of the insulating body, including the individual ducts, is provided with a conductive coating.

1. An insulating body of a plug-in connector, wherein the insulating body is at least partially made from a metallisable plastic, and wherein the insulating body comprises at least one duct provided for receiving a conductor, characterised in that the at least one duct is provided with a conductive coating.

2. The insulating body as claimed in claim 1, characterised in that the conductive coating of the at least one duct is realised using MID technology.

3. The insulating body as claimed in claim 1, characterised in that at least two ducts are provided which are each adapted to receive a conductor of a multicore cable, and that the conductors of the multicore cable are electromagnetically shielded from each other by the conductive coating of the ducts.

4. The insulating body as claimed in claim 1, characterised in that the duct or the ducts are only partially provided with a conductive coating.

5. The insulating body as claimed in claim 1, characterised in that at least one duct is completely and at least one duct partially provided with a conductive coating.

6. The insulating body as claimed in claim 1, characterised in that the plug-in connector is an RJ-45 plug.

7. The insulating body as claimed in claim 1, characterised by a conductive path inserted into the insulating body, which conductive path connects a duct provided with a conductive coating to the plug-in connector housing in a conductive manner.

8. The insulating body as claimed in claim 7, characterised in that the conductive path inserted into the insulating body is realised using MID technology.

9. The insulating body as claimed in claim 1, characterised in that at least two ducts provided with a conductive coating and the plug-in connector housing are electrically contacted with each other via the conductive path.

10. The insulating body as claimed in claim 7, characterised in that the conductive path is connected to the shielding of the cable to be connected.
